(19) United States
(12) Patent Application Publication
(10) Pub. No.: US 2008/0080002 A1
(43) Pub. Date: Apr. 3, 2008

(54) Method and Apparatus for Performing Print Spooling Within a Computer System

(76) Inventor: Cheyenne C. Wills, Boulder, CO (US)

Correspondence Address: DILLON & YUDELL, LLP, 8911 N CAPITAL OF TEXAS HWY, SUITE 2110, AUSTIN, TX, 78759, US

(21) Appl. No.: 11/534,100

(22) Filed: Sep. 21, 2006

(51) Int. Cl. G06K 15/00

(52) U.S. Cl. 358/1.16

(57) ABSTRACT

A method for performing print spooling within a computer is disclosed. The computer is coupled to a disk subsystem and a printer. After the receipt of a print command, the print command is separated into a set of print data and a set of control data. An unique index is associated with each block of the print data, and the indexed print data blocks are then sent to the disk subsystem. The control data are subsequently sent to the processor. In response to the receipt of a command stream generated according to the control data from the processor, the printer directly accesses the indexed print data blocks within the disk subsystem, and then prints the indexed print data blocks.

### BACKGROUND OF THE INVENTION

1. Technical Field

The present invention relates to computer printing in general, and more particularly, to a method and apparatus for performing print spooling within a computer system.

2. Description of Related Art

Print spooling provides a buffer in which print data are loaded, and the print data can be pulled off the buffer when printing is available via a printer. Print spooling allows several print jobs to be placed in a print queue at the same time as well as background printing.

With print spooling, print data typically flows from a software application in which the print data are generated, through a print manager/spooler, and then to a disk subsystem in which the print data are stored. When comes time for the print data to be printed, the print data are read from the disk subsystem by the print manager/spooler within a computer, and the print data are then formatted, if necessary, before being transferred to a printer to be printed.

Modern printers are capable of printing high-resolution images of up to several megabytes in size per page. As the amount of print data per page and the rate at which pages are capable of being printed continue to increase, the speed required to transmit print data to a printer also needs to be increased. The current method of routing spooled print data from a disk subsystem back to a processor before being sent to a printer is very inefficient.

Consequently, it would be desirable to provide an improved method and apparatus for performing print spooling within a computer system.

### SUMMARY OF THE INVENTION

In accordance with a preferred embodiment of the present invention, a computer is coupled to a disk subsystem and a printer. After the receipt of a print command, the print command is separated into a set of print data and a set of control data. An unique index, which is mapped to a physical location of the print data within the disk subsystem, is associated with each block of the print data, and the indexed print data blocks are then sent to the disk subsystem. The control data are retained for later use by a print manager running on the processor. In response to the receipt of a command stream generated according to the control data from the processor, the printer directly accesses the indexed print data blocks within the disk subsystem, and then prints the indexed print data blocks.

All features and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a block diagram of a print spooling environment, in accordance with a preferred embodiment of the present invention; and

FIG. 2 is a high-level logic flow diagram of a method for performing print spooling, in accordance with a preferred embodiment of the invention.

### DETAILED DESCRIPTION OF A PREFERRED EMBODIMENT

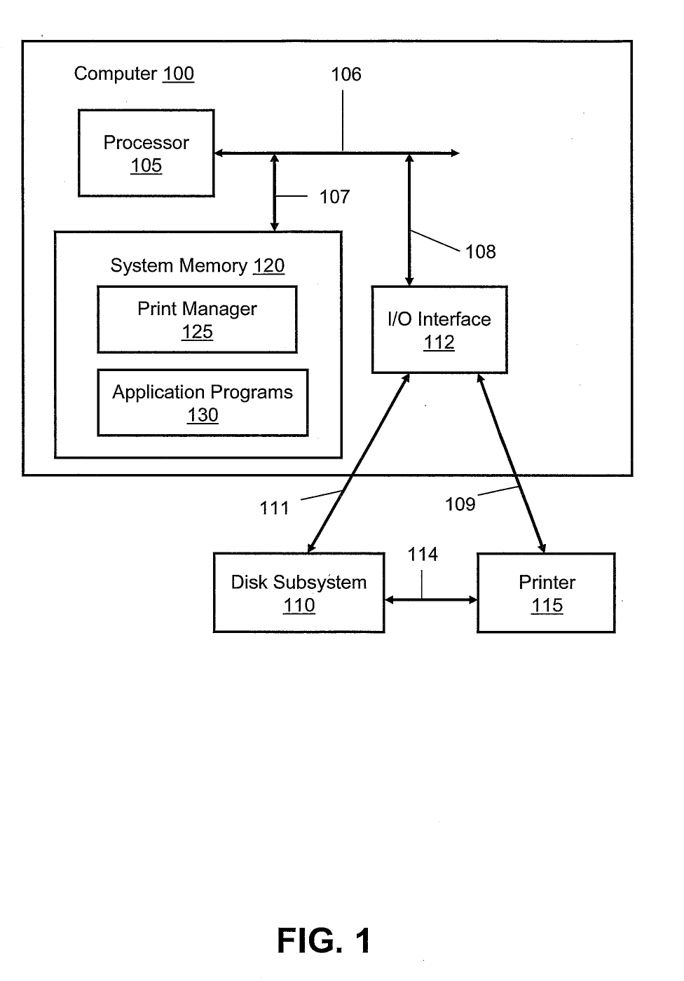

Referring now to the drawings, and specifically to FIG. 1, there is depicted a block diagram of a print spooling environment, in accordance with a preferred embodiment of the present invention. As shown, a computer 100 includes a processor 105, an input/output (I/O) interface 112, and a system memory 120, all connected to a system bus 106. I/O interface 112 is connected to system bus 106 via an I/O bus 108, and system memory 120 is connected to system bus 106 via a memory bus 107. System memory 120 contains a print manager 125 and one or more application programs 130.

Computer 100 is coupled to a disk subsystem 110 and a printer 115. Disk subsystem 110 is connected to I/O interface 112 via a spooling cable 111. Printer 115 is connected to I/O interface 112 via a printer cable 109. Printer 115 is also connected to disk subsystem 110 via a disk access cable 114. Spooling cable 111, printer cable 109 and disk access cable 114 may be Universal Serial Bus (USB) cables, serial I/O cables, or the like. The data transmission rate of disk access cable 114 is preferably higher than that of printer cable 109.

According to the present embodiment, printer cable 109 is utilized for transmitting control data instead of print data. Disk subsystem 110 includes one or more volumes, each of which is subdivided into multiple data blocks, and each of the data blocks has a specific address or index.

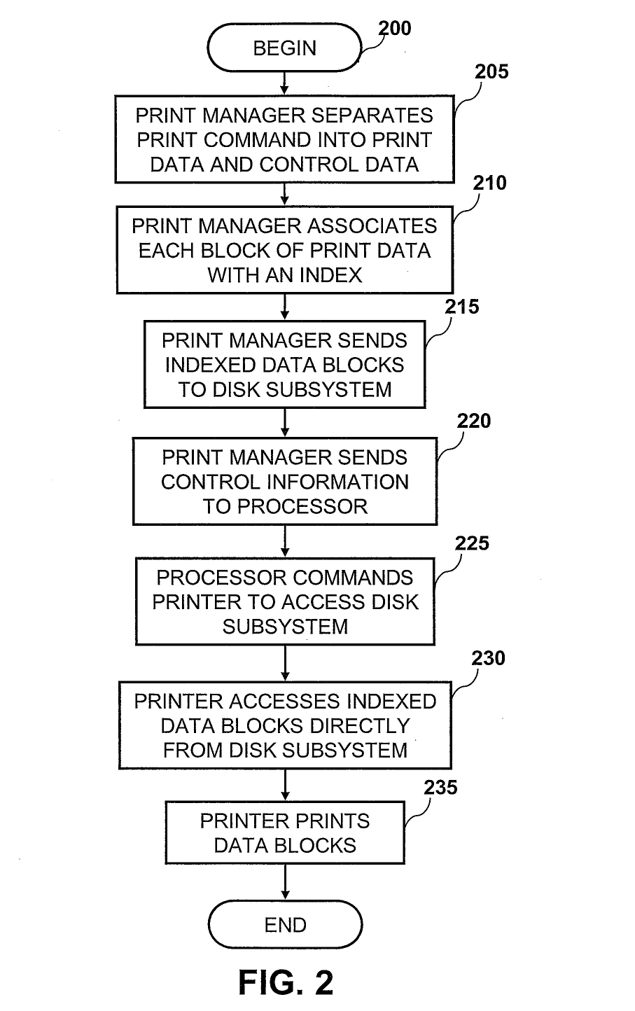

With reference now to FIG. 2, there is illustrated a high-level logic flow diagram of a method for performing print spooling, in accordance with a preferred embodiment of the present invention. Starting at block 200, in response to a print command from an application program, a print manager, such as print manager 125 from FIG. 1, separates the data from the print command into two categories, namely, print data and control data, as shown in block 205. The print data is formatted to be readable by a printer, such as printer 115 from FIG. 1. The control data includes information on the location within a disk subsystem, such as disk subsystem 110 from FIG. 1, in which the print data will be stored.

Next, the print manager generates a set of indexes, and each block of the print data is associated with one of the indexes; as depicted in block 210. The print data blocks are then stored within the disk subsystem along with the control data, as shown in block 215. The indexes can be kept by the print manager or can be stored in a disk subsystem. The indexes enable the printer to efficiently identify and access the data blocks within the disk subsystem via a disk access cable, such as disk access cable 114 from FIG. 1, connected between the disk subsystem and the printer.

Subsequently, the print manager reads the indexes and the control data from a disk subsystem and transmits the control data to a processor, such as processor 105 from FIG. 1, as depicted in block 220. After receiving the control data, the processor utilizes an I/O interface and a printer cable, such as I/O interface 112 and printer cable 109 from FIG. 1, to send a command stream to the printer, as shown in block 225. The command stream includes information to direct the printer to access the indexed data blocks corresponding to the print data located within the disk subsystem. The disk subsystem may require a security authentication code prior to granting access to the printer, so the processor may also send a command stream to the disk subsystem, or gives the printer the authorization code to use, in order to direct the disk subsystem to accept data requests from the printer.

The printer utilizes the disk access cable to access the disk subsystem and reads the specified indexed data blocks directly from the disk subsystem, as depicted in block 230. The printer then prints the indexed data blocks, as shown in block 235, and sends status information to the print manager after the printing has been completed.

As has been described, the present invention provides a method and apparatus for performing print spooling within a computer system. The present invention allows print data to be transmitted directly from a disk subsystem to a printer via a high-capacity disk access cable without routing the print data through a spooling cable, a computer and a printer cable, thereby increasing the speed of the printing process.

While an illustrative embodiment of the present invention has been described in the context of a fully functional computer system with installed software, those skilled in the art will appreciate that the software aspects of an illustrative embodiment of the present invention are capable of being distributed as a program product in a variety of forms, and that an illustrative embodiment of the present invention applies equally regardless of the particular type of signal bearing media used to actually carry out the distribution. Examples of signal bearing media include recordable type media such as floppy disks, hard drives, compact discs, and transmission type media such as digital and analog communication links.

While the invention has been particularly shown and described with reference to a preferred embodiment, it will be understood by those skilled in the art that various changes in form and detail may be made therein without departing from the spirit and scope of the invention.

What is claimed is:

1. A method for performing print spooling within a computer, said method comprising:
in response to the receipt of a print command, separating said print command into print data and control data;
associating each block of said print data with an unique index;
storing said indexed print data blocks to a disk subsystem;
retaining said control data; and
in response to the receipt of a command stream from a processor within said computer, wherein said command stream is generated according to said control data, directly accessing said indexed print data blocks within said disk subsystem by a printer; and
printing said indexed print data blocks by said printer.

2. The method of claim 1, wherein said control data includes information on locations at which said indexed print data blocks are stored in said disk subsystem.

3. The method of claim 1, wherein said accessing further includes accessing said indexed print data blocks within said disk subsystem by said printer via a disk access cable.

4. The method of claim 1, wherein said retaining further includes retaining said control data by said processor.

5. The method of claim 1, wherein said method further includes sending a second command stream to said disk subsystem for directing said disk subsystem to accept data requests from said printer.

6. The method of claim 1, wherein said method further includes sending a third command stream to said printer that includes authorization to direct said disk subsystem to accept data requests from said printer.

7. A computer usable medium having a computer program product for performing print spooling within a computer, said computer usable medium comprising:
program code means for, in response to the receipt of a print command, separating said print command into print data and control data;
program code means for associating each block of said print data with an unique index;
program code means for storing said indexed print data blocks to a disk subsystem;
program code means for retaining said control data; and
program code means for, in response to the receipt of a command stream from a processor within said computer, directly accessing said indexed print data blocks within said disk subsystem by a printer, wherein said command stream is generated according to said control data; and
program code means for printing said indexed print data blocks by said printer.

8. The computer usable medium of claim 7, wherein said control data includes information on locations at which said indexed print data blocks are stored in said disk subsystem.

9. The computer usable medium of claim 7, wherein said program code means for accessing further includes program code means for accessing said indexed print data blocks within said disk subsystem by said printer via a disk access cable.

10. The computer usable medium of claim 7, wherein said computer usable medium further includes program code means for sending said control data from said disk subsystem to said processor.

11. The computer usable medium of claim 7, wherein said computer usable medium further includes program code means for sending a second command stream to said disk subsystem for directing said disk subsystem to accept data requests from said printer.

12. The computer usable medium of claim 7, wherein said computer usable medium further includes program code means for sending a third command stream to said printer that includes authorization to direct said disk subsystem to accept data requests from said printer.

13. An apparatus for performing print spooling within a computer, said apparatus comprising:
means for, in response to the receipt of a print command, separating said print command into print data and control data;
means for associating each block of said print data with an unique index;
means for storing said indexed print data blocks to a disk subsystem;
means for retaining said control data; and
means for, in response to the receipt of a command stream from a processor within said computer, directly accessing said indexed print data blocks within said disk subsystem by a printer, wherein said command stream is generated according to said control data; and
program code means for printing said indexed print data blocks by said printer.

14. The apparatus of claim 13, wherein said control data includes information on locations at which said indexed print data blocks are stored in said disk subsystem.

15. The apparatus of claim 13, wherein said means for accessing further includes means for accessing said indexed print data blocks within said disk subsystem by said printer via a disk access cable.

16. The apparatus of claim 13, wherein said apparatus further includes means for sending said control data from said disk subsystem to said processor.

17. The apparatus of claim 13, wherein said apparatus further includes means for sending a second command stream to said disk subsystem for directing said disk subsystem to accept data requests from said printer.

18. The apparatus of claim 13, wherein said apparatus further includes means for sending a third command stream to said printer that includes authorization to direct said disk subsystem to accept data requests from said printer.
